(19) United States
(12) Patent Application Publication
(10) Pub. No.: US 2014/0032327 A1
(43) Pub. Date: Jan. 30, 2014

(54) COMMUNICATION SYSTEM INCLUDING DIGITAL SIGNAGE AND RELATED MOBILE CONTENT

(71) Applicants: Gyan Prakash, Beaverton, OR (US); Nagasubramanian Gurumoorthy, Portland, OR (US); Kaitlin A. Murphy, Sunnyvale, CA (US); Rajesh Poornachandran, Portland, OR (US)

(72) Inventors: Gyan Prakash, Beaverton, OR (US); Nagasubramanian Gurumoorthy, Portland, OR (US); Kaitlin A. Murphy, Sunnyvale, CA (US); Rajesh Poornachandran, Portland, OR (US)

(21) Appl. No.: 13/557,003

(22) Filed: Jul. 24, 2012

(51) Int. Cl. G06Q 30/02

(52) U.S. Cl. CPC G06Q 30/0251
USPC 705/14.64; 705/14.4; 705/14.66

(57) ABSTRACT

A system may include a signage controller configured to control digital signage (e.g., at least one digital display). In one embodiment, the signage controller may collect and compile demographic information and feedback from mobile devices via close-proximity or short-range communication prior to providing it to cloud resources. The cloud resources may then determine content and mobile content based on the demographic information and feedback. At least the content may be provided to the signage controller, which may cause the digital signage to display some of the content (e.g., at least one advertisement). The mobile content may be pushed to the mobile devices, and may cause the mobile devices to display information and/or provide functionality related to the displayed content. In one embodiment, statistics (e.g., at least one of offer availability or offer acceptance statistics corresponding to the at least one advertisement) may also be displayed on the digital signage.

### TECHNICAL FIELD

The present disclosure relates to communication systems, and more particularly, to systems configured to display content and provide related material to proximate mobile devices.

### BACKGROUND

Advertisers that employ public displays (e.g., signs, billboards, posters, etc.) designed to catch the attention of pedestrians, commuters, drivers, etc. have a difficult objective to achieve in today's marketplace. In particular, these advertisers must attempt to get their message across to increasingly distracted targets. For example, in the brief instant that potential consumers view the advertising they may also be distracted by a variety of activities that demand their attention including, for example, information delivered by a multitude of sources, increasing congestion due to population growth, etc. At an instant when a person may be able to view a public display he/she may also be navigating through very heavy traffic, interacting with their mobile device, looking for a parking place, etc. Potential consumers are multitasking more and more, allowing less attention to be paid to any particular activity including viewing a particular advertisement.

In addition, advancements in digital video technology and wireless communication have yielded public displays that change constantly, making it even harder for advertisers to get their message conveyed. Now, even if potential consumers do have the opportunity to view a public display device, the chances of advertisements of interest being viewed are substantially reduced by the fact that the advertisements are constantly changing, thus introducing the timing of when the potential consumer views the public display also becomes a factor. In addition, while public displays that constantly change may allow many retailers to advertise in one location, they do not allow people to view and fully comprehend the offers that are being presented. As a result, while potential consumers may be able to associate an advertisement with a particular retailer, they may not be able to determine whether the offers are good deals, would be valuable to them, etc.

### BRIEF DESCRIPTION OF THE DRAWINGS

Features and advantages of various embodiments of the claimed subject matter will become apparent as the following Detailed Description proceeds, and upon reference to the Drawings, wherein like numerals designate like parts, and in which:

FIG. 1 illustrates an example communication system including digital signage and related mobile contentin accordance with at least one embodiment of the present disclosure;

FIG. 2 illustrates an example configuration for a signage controller in accordance with at least one embodiment of the present disclosure;

FIG. 3 illustrates an example of information flow through a security engine in accordance with at least one embodiment of the present disclosure;

FIG. 4 illustrates an example of information flow through cloud resources in accordance with at least one embodiment of the present disclosure; and

FIG. 5 illustrates a flowchart of example operations for an example communication system including digital signage and related mobile contentin accordance with at least one embodiment of the present disclosure.

Although the following Detailed Description will proceed with reference being made to illustrative embodiments, many alternatives, modifications and variations thereof will be apparent to those skilled in the art.

### DETAILED DESCRIPTION

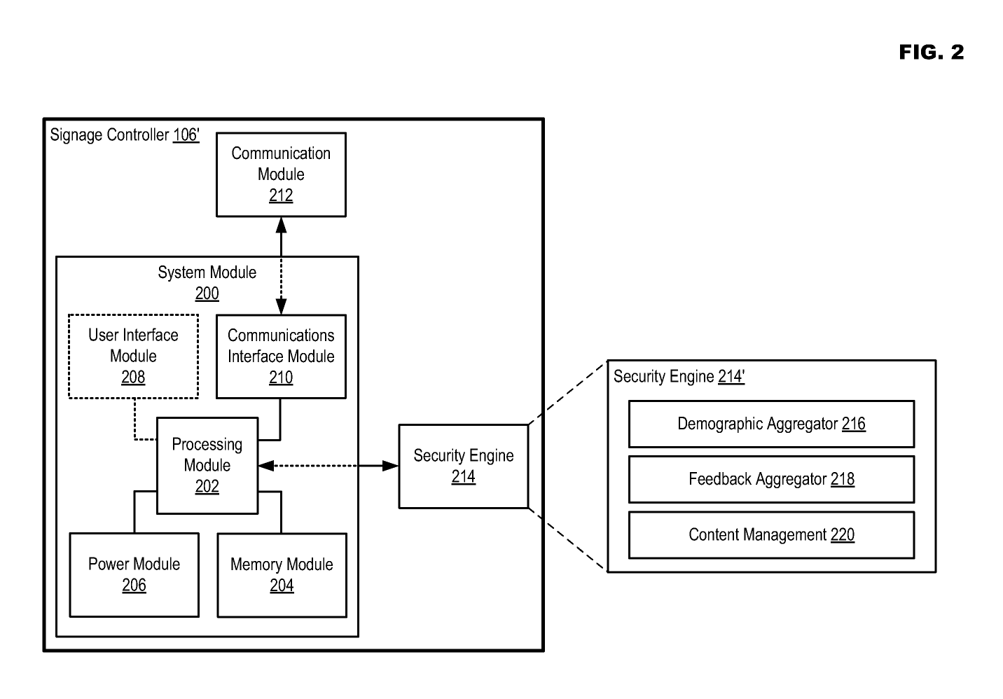

This disclosure describes systems and methods related to an advertising system including statistical feedback. Initially, some terminology will be utilized for the purpose of explanation in the following disclosure. “Digital signage,” or more generally, “signage” may include electronic advertising displays of any size utilized to present content including advertisements to potential consumers. Digital signage is not limited by size or technology, and may include large displays (e.g., billboards, large wall displays, etc.) and small displays (e.g., small screens situated in areas such as elevators, shopping malls, on public transportation, etc.) employing various technologies such as, for example, cathode ray tube (CRT), liquid crystal (LCD), plasma, light emitting diode (LED), active-matrix organic LED (AMOLED), etc. “Content” may include information that is displayable on the digital signage. For example, content may include one or more still images, video or combinations of still images and video. Content may also include audio information configured to accompany displayable information. In embodiments consistent with the present disclosure, the subject matter of the content may include at least some advertising material (e.g., advertisements) in the form of, for example, commercials, testimonials, reviews, offers, coupons, etc. “Cloud resources” may include processing equipment such as, but not limited to, computers, servers, etc., configured to interact with various devices via a wide area network (WAN) like the Internet. For example, cloud resources may include web servers, storage servers, etc. configured to receive requests via the Internet, to perform activities related to the requests and to respond to the requests. “Close-proximity” wireless communication may include wireless communication mediums that are typically limited to operation at a maximum distance of up to ten centimeters, while “short-range” wireless communications may include wireless communication mediums that can operate at distances up to ten meters. Examples of “close-proximity” and “short-range” wireless communication mediums will be discussed in reference to FIG. 2.

In one embodiment, a communication system including digital signage and related mobile content may comprise, for example, digital signage, a signage controller, cloud resources and at least one mobile device. The signage controller may be configured to collect information and feedback from the at least one mobile device. The information may be collected using, for example, close-proximity or short-range wireless communication. The signage controller may compile the information and the feedback, and may provide the compiled information and the feedback to the cloud resources. The cloud resources may use the information and feedback for determining at least content and mobile content. The content may be provided to the signage controller, which may cause the digital signage to display the content. The mobile content may be pushed to the at least one mobile device from the cloud resources or the signage controller.

In the same or a different embodiment, the information collected from the at least one mobile device may be related to a user of the mobile device (e.g., demographic information). For example, the information may be provided by an application executing in the at least one mobile device such as a social media application or an application for shopping, discounts, coupons, etc. The demographic information (e.g., gender, age, occupation, interests, etc.) may be compiled with demographic information received from other devices within communication range of the digital signage to determine content and statistics to display that are relevant to the users that are close to the digital signage. Content may include at least an advertisement, while the mobile content may be configured to cause acceptance and refusal options for an offer related to the advertisement to be displayed on the mobile device. The mobile content may further cause the mobile device to facilitate an acceptance or refusal of the offer by a device user, and to cause the mobile device to provide feedback to the cloud resources directly, or to the signage controller regarding the acceptance or refusal of the offer by the device user. In one embodiment, statistics may be determined (e.g., by the cloud resources) based on the feedback information received from the at least one mobile device, and the statistics may be displayed on the digital signage along with the associated content (e.g., the at least one advertisement). The at least one mobile device may be further configured to filter incoming mobile content (e.g., so mobile content for only certain retailers, categories, offer types, etc. may be received) and/or store the mobile content so that a user of the at least one device may view the mobile content at a later time.

In the same or a different embodiment, the signage controller may comprise, for example, a security engine configured to prevent the signage controller from being compromised through unauthorized access. The security engine may comprise, for example, a demographic aggregator configured to collect and compile demographic information, a feedback aggregator configured to collect and compile feedback, and content management configured to control the content displayed on the digital signage. Moreover, the cloud resources may comprise, for example, a demographic inference engine configured to process the compiled demographic information, a statistics inference configured to process the compiled feedback, and a content management engine configured to determine the content and the mobile content based on the processed demographic information and the processed feedback.

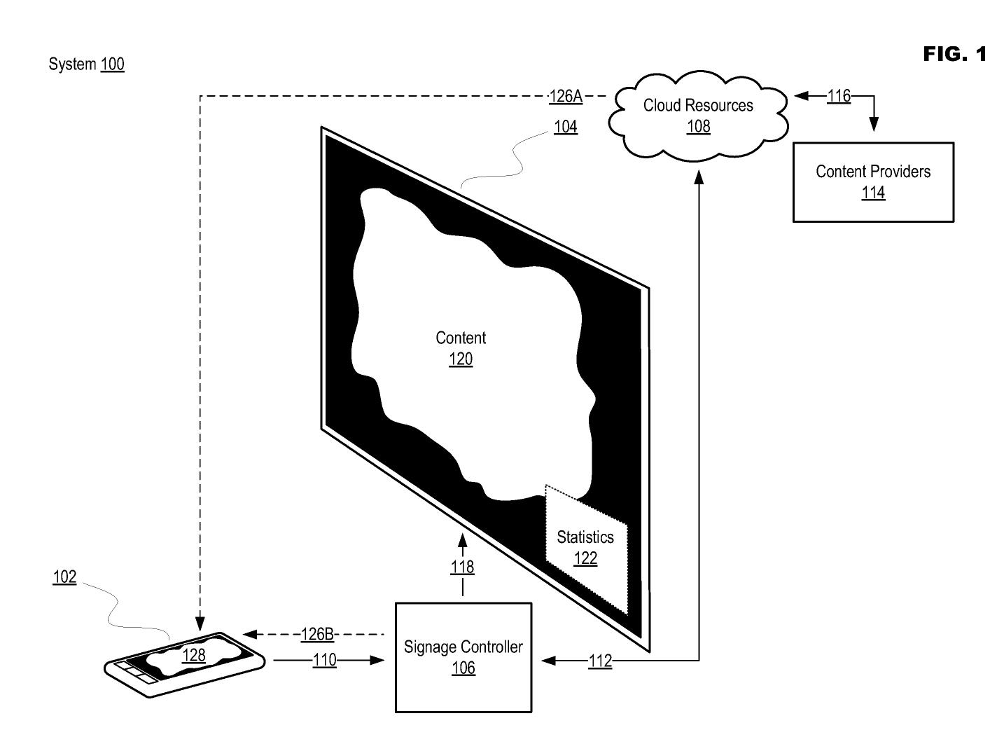

FIG. 1 illustrates an example advertising system including statistical feedback (hereafter, “system 100”) in accordance with at least one embodiment of the present disclosure. System 100 may include, for example, at least one mobile device 102, digital signage 104, signage controller 106 and cloud resources 108. Examples of mobile device 102 may include, but are not limited to, a mobile communication device such as a cellular handset or a smartphone based on the Android® operating system (OS), iOS®, Blackberry® OS, Palm® OS, Symbian® OS, etc., a mobile computing device such as a tablet computer like an iPad®, Galaxy Tab®, Kindle Fire®, etc., an Ultrabook® including a low-power chipset manufactured by Intel Corp., a netbook, a notebook computer, a laptop computer, etc. Mobile device 102 may be configured, for example, with an application configured to make information (e.g., demographic information) available for collection by signage controller 106 as shown at 110. Demographic information may include, for example, information about a user of mobile device 102 such as gender, age, locations (e.g., home and/or work addresses), affiliations (e.g., professional groups, discount club memberships, etc.), interests, etc. While FIG. 1 illustrates only one mobile device 102, there may be a plurality of mobile devices in communication range of digital signage 104 and/or signage controller 106 (e.g., established by the close-proximity and/or short-range communication mediums utilized by signage controller 106). Signage controller 106 may collect demographic from any or all of the devices within range and may compile the demographic information prior to providing it to cloud resources as shown at 112. Compilation may include, for example, generating totals for certain categories useful for selecting content 120 (e.g., including advertisements) such as gender, age affiliations, etc., averaging certain categories, generating weighted averages, and/or any other statistical computation that may be utilized to track the number of users within communication range of signage controller 106 that fall into certain categories usable for selecting content 120.

Cloud resources 108 may receive at least the demographic information from signage controller 106 as shown at 112. Cloud resources 108 may utilize the demographic information, possibly in combination with feedback information collected either directly from mobile device 102, or as collected and compiled by signage controller 106, in determining content 120 and mobile content 128. In one embodiment, cloud resources 108 may also determine statistics 122. Content 120 may be provided to cloud resources 108 by, for example, content providers 114. Content providers may include advertisers (e.g., manufacturers, retailers, service providers, etc.) that may provide content 120 and/or receive feedback regarding content 120 that was previously provided as shown at 116. For example, the feedback provided to content providers 114 may be beneficial for improving content (e.g., advertisements), creating offers that are more appealing to consumers, determining the interest in new products, etc. Cloud resources 108 may then provide at least content 120 to signage controller 106, which may cause at least some of content 120 to be displayed on digital signage 104 as shown at 118. For example, content 120 may include at least one advertisement, and signage controller 106 may cause the at least one advertisement in content 120 to be displayed on digital signage 104. In one embodiment, cloud resources 108 may be configured to perform the above activities for a plurality of digital signage 104 (e.g., may provide content 120 for display on multiple digital signs in different locations) concurrently.

In one embodiment, statistics 122 may also be provided to signage controller 106 along with content 120, and may be displayed along with content 120 as illustrated in FIG. 1. Statistics 122 may include, for example, offer availability and offer acceptance information corresponding to advertisements in content 120. Offer availability information may include, for example, the length of time that discounts, special rates, limited editions, etc. will be offered, the number of offers still remaining (e.g., if the offer only corresponds to the sale of a certain number of units, etc.), the locality of the offer (e.g., if the offer is available within a certain geographical area or a certain distance from digital signage 104), etc. Offer acceptance information may include the number of offers accepted by consumers. For example, for certain offer providers like “Groupon,” only a limited number of spots are available to take advantage of an offer. The offer acceptance information may provide insight to potential consumers as to the popularity of the offer (e.g., is it actually a good offer) and how fast the potential consumers must act to take advantage of the offer (e.g., if only a few spots are left the potential consumer must act quickly to take advantage of the offer). The generation of statistics 122 by, for example, cloud resources 108, and the provision of statistics 122 to signage controller 106 for display on digital signage 104, may depend upon the at least one advertisement in content 120. For example, offers from larger venders (e.g., department stores, fast food chains, etc.) often do not have availability or acceptance limitations, do not have statistics that would be useful to potential consumers, etc., and thus, would not typically be displayed on digital signage 104 along with statistics 122.

In one embodiment, potential consumers may take advantage of offers (e.g., as advertised on digital signage 104) using mobile content 128, which may be pushed to mobile device 102 as shown at 126A. In an alternative configuration consistent with the present disclosure, it may be possible for cloud resources 108 to provide mobile content 128 to signage controller 106, and for signage controller 106 to push mobile content 128 to mobile device 102 as shown at 126B (e.g., via close-proximity or short-range wireless communication). Regardless of how it arrives on mobile device 102, mobile content 128 may correspond to content 120 displayed on digital signage 104. At least one benefit of mobile content 128 is that potential consumers that are distracted from viewing content 120 on digital signage 104 may still view important information in mobile content 128 (e.g., offers, sales, coupons, etc.) corresponding to content 120 at their leisure. For example, mobile device 102 may store mobile content 128 corresponding to more than content 120 that was displayed, and may be able to review mobile content 128 at a later time. To avoid potential consumers becoming overwhelmed with offers, an application in mobile device 102 (e.g., the application that provided the demographic information) may be configured to filter mobile content 128 so that only certain information is viewable and/or stored. For example, mobile content 128 may be filtered based by geographic area in which offers are available, by advertiser (e.g., retailer, manufacturer, etc.), by the time period in which the offers are valid, etc.

In the same or a different embodiment, mobile content 128 may cause mobile device 102 to display acceptance and refusal options for a particular offer. For example, content 120 that is being displayed on digital signage 120 may include an advertisement of a certain offer. Mobile content 128 may cause mobile device 102 to display options for accepting or declining the offer. Accepting the offer may, for example, cause purchase options to be available on mobile device 102 (e.g., via the application, an Internet browser, messaging services, etc.). In one possible configuration, refusing the offer may cause an interface to be displayed on mobile device 102, the interface allowing the user to provide reasons as to why the offer was declined. For example, the interface may include predetermined options allowing the user to indicate that they are not interested in the product, do not think that the offer is a good deal, do not use or trust the offering party, etc., possibly along with text areas for further user input. This feedback may be provided to signage controller 106, or alternatively directly to cloud resources 108, for use in determining future content 120, for updating statistics 122 and to provide feedback to content providers 114.

FIG. 2 illustrates an example configuration for signage controller 106′ in accordance with at least one embodiment of the present disclosure. Signage controller 106′ may comprise at least system module 200, which may be configured to manage normal operations in signage controller 106′. System module 200 may comprise, for example, processing module 202, memory module 204, power module 206, user interface module 208 and communications interface module 210, which may be configured to interact with communication module 212. Further, security engine 214 may be configured to interact with at least processing module 202 in system module 200. While communication modules 212 and 214 have been shown separately from system module 200, the illustrated configuration is merely for the sake of explanation herein. Some or all of the functionality associated with modules 212 and 214 may also be included in system module 200.

For example, processing module 202 may comprise one or more processors situated in separate components, or alternatively, may comprise one or more processing coresembodied in a single component (e.g., in a System-on-a-Chip (SOC) configuration) and any processor-related support circuitry (e.g., bridging interfaces, etc.). Example processors may include various x86-based microprocessors available from the Intel Corporation including those in the Pentium, Xeon, Itanium, Celeron, Atom, Core i-series product families. Examples of support circuitry may include chipsets (e.g., Northbridge, Southbridge, etc. available from the Intel Corporation) configured to provide an interface through which processing module 202 may interact with other system components that may be operating at different speeds, on different buses, etc. in signage controller 106′. Processing module 202 may be configured to execute instructions in signage controller 106′. Instructions may include program code configured to cause processing module 202 to perform activities related to reading data, writing data, processing data, formulating data, converting data, transforming data, etc. Information (e.g., instructions, data, etc.) may be stored in memory module 204. Memory module 204 may comprise random access memory (RAM) or read-only memory (ROM) in a fixed or removable format. RAM may include memory configured to hold information during the operation of signage controller 106′ such as, for example, static RAM (SRAM) or Dynamic RAM (DRAM). ROM may include memories such as bios memory configured to provide instructions when signage controller 106′ activates, programmable memories such as electronic programmable ROMs (EPROMS), Flash, etc. Other fixed and/or removable memory may include magnetic memories such as floppy disks, hard drives, etc., electronic memories such as solid state flash memory (e.g., embedded multimedia card (eMMC), etc.), removable memory cards or sticks (e.g., micro storage device (uSD), USB, etc.), optical memories such as compact disc-based ROM (CD-ROM), etc. Power module 206 may include internal power sources (e.g., a battery) and/or external power sources (e.g., electromechanical or solar generator, power grid, etc.), and related circuitry configured to supply signage controller 106′ with the power needed to operate.

In one embodiment, user interface module 208 may be optional in system module 200 in that signage controller 106′ may be situated in a location that is not readily accessible for direct user access (e.g., integrated with digital signage 104 which is a billboard, a sign on the side of a building, a sign in public transportation, etc.), and thus, interaction with signage controller 106′ may take place remotely (e.g., via wired or wireless communication with communication module 212). User interface module 208 may include circuitry configured to allow users to interact with signage controller 106′ such as, for example, various input mechanisms (e.g., microphones, switches, buttons, knobs, keyboards, speakers, touch-sensitive surfaces, one or more sensors configured to capture images and/or sense proximity, distance, motion, gestures, etc.) and output mechanisms (e.g., speakers, displays, lighted/flashing indicators, electromechanical components for vibration, motion, etc.). Communications interface module 210 may be configured to handle packet routing and other control functions for communication module 212, which may include resources configured to support wired and/or wireless communications. Wired communications may include serial and parallel wired mediums such as, for example, Ethernet, Universal Serial Bus (USB), Firewire, etc. Wireless communications may include, for example, close-proximity wireless mediums (e.g., radio frequency (RF) such as based on the Near Field Communications (NFC) standard, infrared (IR), optical character recognition (OCR), magnetic character sensing, etc.), short-range wireless mediums (e.g., Bluetooth, wireless local area networking (WLAN), Wi-Fi, etc.) and long range wireless mediums (e.g., cellular, satellite, etc.). In one embodiment, communications interface module 210 may be configured to prevent wireless communications that are active in communication module 212 from interfering with each other. In performing this function, communications interface module 210 may schedule activities for communication module 212 based on, for example, the relative priority of messages awaiting transmission.

Security engine 214 may be a software and/or hardware-based (e.g., firmware) execution environment that is insulated from other modules in signage controller 106′. The protection that is offered by security engine 214 helps to ensure that no other module in signage controller 106′ (e.g., a module compromised via unauthorized external access) can affect the functionality being performed within security engine 214. As a result, unauthorized external users having criminal or fraudulent intentions may be barred from gaining access to any personal information collected by signage controller 106′, may be prevented from changing and/or corrupting content 120 or statistics 122 prior to display on digital signage 104, may be prevented from inserting fraudulent and/or inappropriate content 120 for display on digital signage 104, etc. Security engine 214 is added security allowing content providers 114 to feel safe in that their content will be displayed accurately, as well as potential consumers to feel safe in providing any personal information.

In one example configuration, security engine 214′ may include demographic aggregator 216, feedback aggregator 218 and content management 220. Demographic aggregator 216 may be configured to collect information from mobile device 102 (e.g., via close-proximity or short-range wireless communication through communication module 212). When a plurality of mobile devices 102 are within communication range of signage controller 106′, demographic aggregator 216 may collect information from the plurality of mobile devices 102 and may then compile the collected demographic information. Feedback aggregator 218 may collect feedback from mobile device 102, and similarly to demographic aggregator 216, may compile feedback from more than one mobile device 102. Content management 220 may be configured to receive content 120 and statistics 122 (and possibly mobile content 128) from cloud resources 108, and to control digital signage 104 in displaying at least some of content 120. For example, content management 220 may be configured to cause digital signage 104 to display at least one advertisement provided by content 120. In one embodiment, the at least one advertisement may be displayed along with corresponding offer availability and offer acceptance statistics provided by statistics 122.

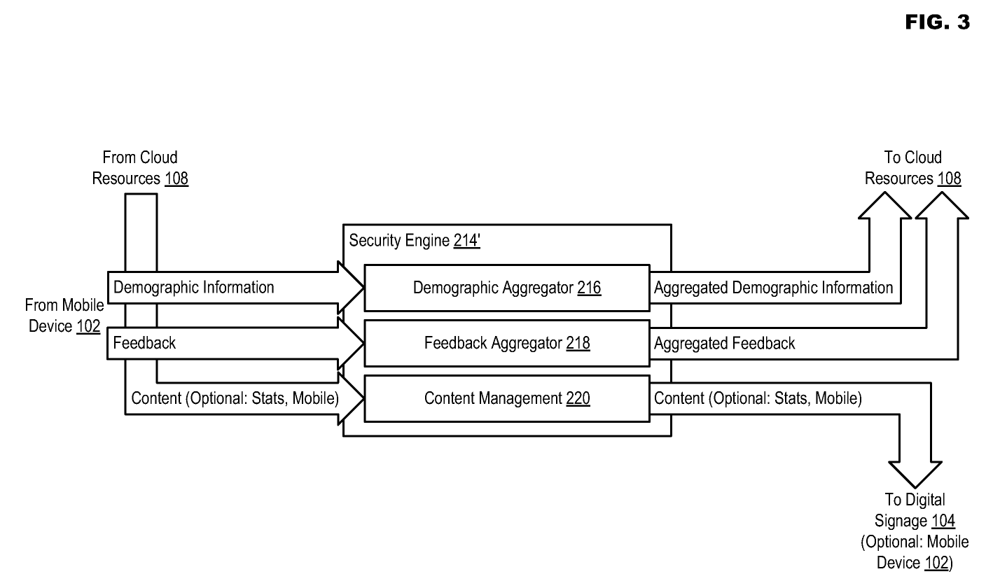

FIG. 3 illustrates an example of information flow through security engine 214′ in accordance with at least one embodiment of the present disclosure. In one embodiment, demographic information and feedback may be received from at least one mobile device 102 in demographic aggregator 216 and feedback aggregator 218. Demographic information may include information pertaining to a user of mobile device 102 that may be employed in determining content 120 to display on digital signage 104. Feedback may include response information from the user of the mobile device 102 as to acceptance or refusal of offers presented in content 120, possibly along with rationale as to why the offers were accepted or refused. If more than one mobile device 102 is present within communication range of signage controller 106′, then demographic aggregator 216 and feedback aggregator 218 may compile demographic information and feedback from some or all of the mobile devices 102 to arrive at aggregated demographic information and aggregated feedback. Demographic aggregator 216 and feedback aggregator 218 may then forward the aggregated demographic information and the aggregated feedback to cloud resources 108 for processing. Content management 220 may then receive at least content 120 from cloud resources 108, and may cause digital signage 104 to display at least some of content 120 (e.g., at least one advertisement). In one embodiment, content management 220 may also receive statistics 122 and/or mobile content 128. In the instance that statistics 122 are received, content management 220 may cause digital signage 104 to display at least some of statistics 122 (e.g., offer availability and acceptance information) along with the corresponding content 120. If mobile content 128 is also received, content management 220 may also cause mobile content 128 to be pushed out to mobile device 102 via, for example, close-proximity or short-range wireless communication.

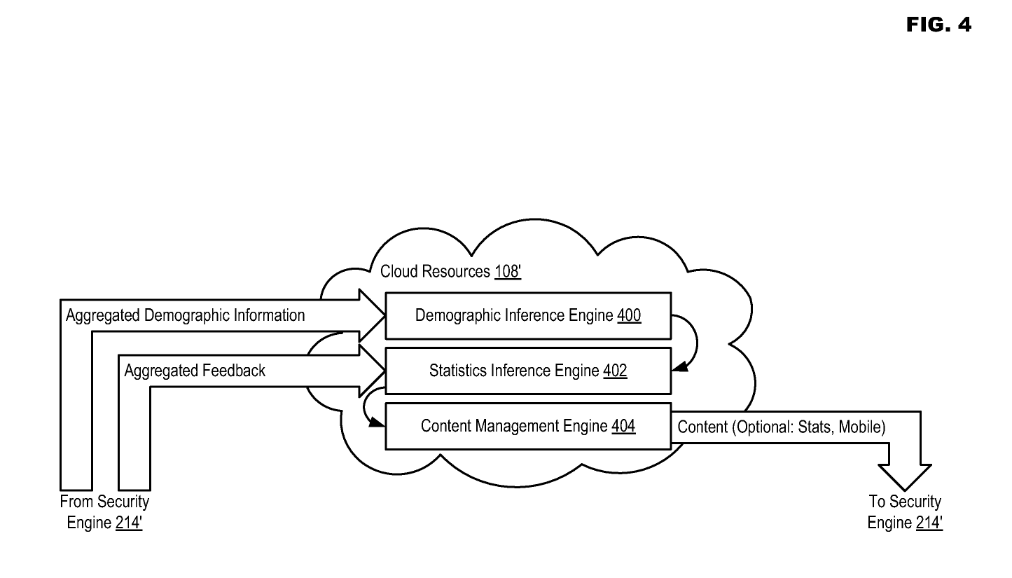

FIG. 4illustrates an example of information flow through cloud resources 108′ in accordance with at least one embodiment of the present disclosure. In one embodiment, the aggregated demographic information and aggregated feedback are received in cloud resources 108′ by demographic inference engine 400 and statistic inference engine 402, respectively. Demographic inference engine 400 may be configured to select from content (e.g., provided by content providers 114) based on the aggregated demographic information. For example, the aggregated demographic information may indicate that the potential consumers within range of signage controller 106′ may be predominately of a particular gender, may be in a particular age group, may have income in a certain range, may be from a certain geographic area, may have common interests, may have certain affiliations, etc. A group of content may be selected based on these characteristics. The group of content identified by demographic engine 400 may then be filtered by statistics inference engine 402 based on the received aggregated feedback. For example, the aggregated feedback may demonstrate a degree of acceptance or rejection of some of the content, or of offers associated with some of the content, by users within range of signage controller 106′. For example, content that was overwhelmingly rejected may be removed from the group of content originally identified by demographic inference engine 400. Other example statistics that may also be considered may include the number of spots/time left to accept an offer being advertised in content, regional limitations of offers being advertised in content, feedback on whether an offer advertised in content is incorrect (e.g., the offer was accepted by users but turned out to be different when the users attempted to redeem it), etc. The filtered group of content may then be provided to content management engine 404. Content management engine 404 may make the ultimate determination of whether to send content out to signage controller 106′. For example, content management engine 404 may determine if certain content is already being displayed nearby, was already displayed recently, if contractually certain content should not be distributed (e.g., content provider 114 has not paid for the certain content to be displayed, the certain content has already been displayed to the extent required by contract, etc.), etc. Content management engine 404 may then send some or all of the content that was forwarded for consideration by statistics inference engine 402 to security engine 214′ in signage controller 106′. In one embodiment, content management engine 404 may also provide statistics 122 (e.g., as determined by statistics inference engine 402) and mobile content 128 to security engine 214′.

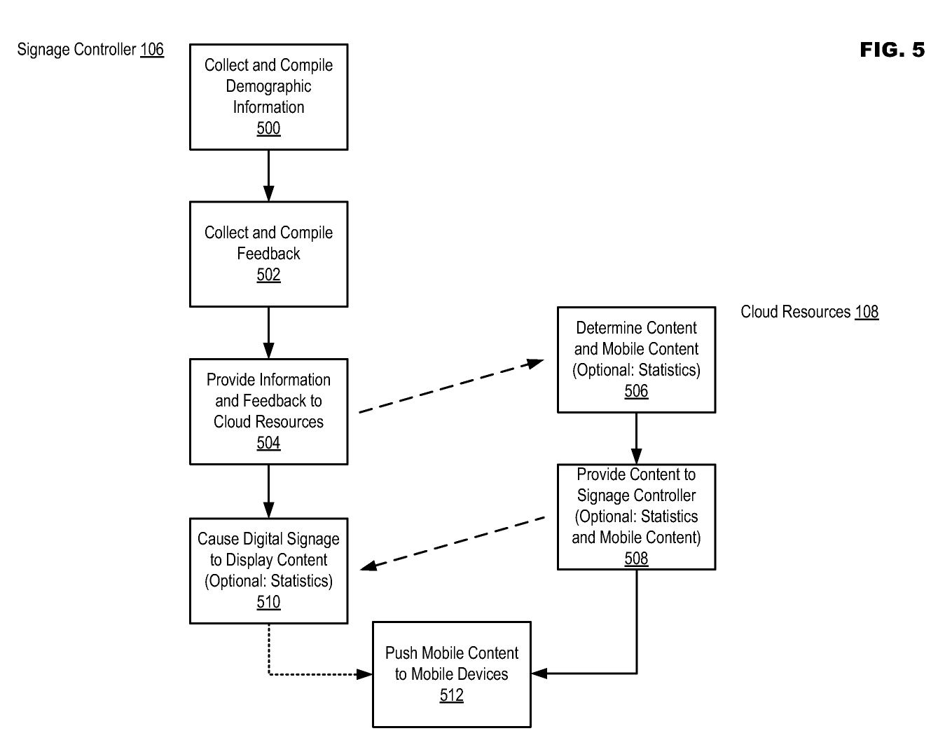

FIG. 5 illustrates a flowchart of example operations for an example advertising system including statistical feedback in accordance with at least one embodiment of the present disclosure. In one embodiment, operations 500-504 and 510 may be performed in signage controller 106, operations 506 and 508 may be performed in cloud resources 108, and operation 512 may be performed by either signage controller 106 or cloud resources 108 depending on the configuration of system 100. In operation 500, demographic information may be collected and compiled by signage controller 106, while in operation 502 feedback may also be collected and compiled by signage controller 106. For example, the demographic information and feedback may be collected from at least one mobile device 102 within communication range of signage controller 106 via close-proximity or short-range wireless communication. In operation 504, the compiled demographic information and feedback may be provided to cloud resources 108.

Cloud resources 108 may then determine at least content and mobile content based on the compiled demographic information and feedback in operation 506. In at least one embodiment, cloud resources 108 may also determine statistics in operation 506. In operation 508, at least the content (and optionally the statistics and/or the mobile content) may be provided to the signage controller 106. In operation 510, signage controller 106 may then cause digital signage 104 to display at least some of the content (e.g., to display at least one advertisement). In at least one embodiment, if statistics were also provided to signage controller 106 by cloud resources 108, then statistics may also be displayed (e.g., at least one of offer availability and offer acceptance statistics corresponding to the at least one advertisement). In operation 512, mobile content may then be pushed out to the at least one mobile device 102 within communication range of signage controller 106. In at least one embodiment, cloud resources 108 may push the mobile content directly to the at least one mobile device via long-range (e.g., cellular) wireless communication. However, if cloud resources 108 also provided the mobile content to signage controller 106 in operation 508, signage controller 106 may be able to push the mobile content out to the at least one mobile device 102 via, for example, close-proximity or short-range wireless communication.

While FIG. 5 illustrates various operations according to an embodiment, it is to be understood that not all of the operations depicted in FIG. 5 are necessary for other embodiments. Indeed, it is fully contemplated herein that in other embodiments of the present disclosure, the operations depicted in FIG. 5, and/or other operations described herein, may be combined in a manner not specifically shown in any of the drawings, but still fully consistent with the present disclosure. Thus, claims directed to features and/or operations that are not exactly shown in one drawing are deemed within the scope and content of the present disclosure.

As used in any embodiment herein, the term “module” may refer to software, firmware and/or circuitry configured to perform any of the aforementioned operations. Software may be embodied as a software package, code, instructions, instruction sets and/or data recorded on non-transitory computer readable storage mediums. Firmware may be embodied as code, instructions or instruction sets and/or data that are hard-coded (e.g., nonvolatile) in memory devices. “Circuitry”, as used in any embodiment herein, may comprise, for example, singly or in any combination, hardwired circuitry, programmable circuitry such as computer processors comprising one or more individual instruction processing cores, state machine circuitry, and/or firmware that stores instructions executed by programmable circuitry. The modules may, collectively or individually, be embodied as circuitry that forms part of a larger system, for example, an integrated circuit (IC), system on-chip (SoC), desktop computers, laptop computers, tablet computers, servers, smart phones, etc.

Any of the operations described herein may be implemented in a system that includes one or more storage mediums having stored thereon, individually or in combination, instructions that when executed by one or more processors perform the methods. Here, the processor may include, for example, a server CPU, a mobile device CPU, and/or other programmable circuitry. Also, it is intended that operations described herein may be distributed across a plurality of physical devices, such as processing structures at more than one different physical location. The storage medium may include any type of tangible medium, for example, any type of disk including hard disks, floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic and static RAMs, erasable programmable read-only memories (EPROMs), electrically erasable programmable read-only memories (EEPROMs), flash memories, Solid State Disks (SSDs), embedded multimedia cards (eMMCs), secure digital input/output (SDIO) cards, magnetic or optical cards, or any type of media suitable for storing electronic instructions. Other embodiments may be implemented as software modules executed by a programmable control device.

Thus, the present disclosure is directed to a communication system including digital signage and related mobile content. The system may include a signage controller configured to control digital signage (e.g., at least one digital display). In one embodiment, the signage controller may collect and compile demographic information and feedback from mobile devices via close-proximity or short-range communication prior to providing it to cloud resources. The cloud resources may then determine content and mobile content based on the demographic information and feedback. At least the content may be provided to the signage controller, which may cause the digital signage to display some of the content (e.g., at least one advertisement). The mobile content may be pushed to the mobile devices, and may cause the mobile devices to display information and/or provide functionality related to the displayed content. In one embodiment, statistics (e.g., and at least one of offer availability or offer acceptance statistics corresponding to the at least one advertisement) may also be displayed on the digital signage.

The following examples pertain to further embodiments. In one example embodiment there is provided a system. The system may include digital signage configured to display content, at least one mobile device configured to receive mobile content related to the content, cloud resources configured to determine the content and the mobile content based on information and feedback, and a signage controller configured to collect the information and the feedback from the at least one mobile device, to provide the information and the feedback to the cloud resources, to receive the content from the cloud resources and to cause the digital signage to display the content.

The above example system may be further configured, wherein the content includes at least one advertisement. In this configuration, the example system may be further configured, wherein the mobile content is configured to cause the at least one mobile device to display acceptance and refusal options for an offer related to the at least one advertisement, to facilitate acceptance or refusal of the offer by a device user, and to provide the feedback to at least the signage controller based on the acceptance or refusal of the offer. In this configuration, the example system may be further configured, wherein the digital signage is further configured to display statistics along with displaying the content, the statistics including at least one of offer acceptance or offer availability statistics for the at least one advertisement based on the feedback.

The above example system may be further configured, wherein the mobile device is further configured to receive the mobile content from at least one of the cloud resources or the signage controller. In this configuration, the example system may be further configured, wherein the information includes at least demographic information corresponding to a user of the at least one mobile device, the demographic information being made available by an application executing on the at least one mobile device. In this configuration, the example system may be further configured, wherein the application is a social media application. In this configuration, the example system may be further configured, wherein the application is further configured to at least one of filter or store the mobile content received by the at least one mobile device based on a configuration in the application. In this configuration, the example system may be further configured, wherein the signage controller comprises a security engine configured to prevent the signage controller from being compromised through unauthorized access. In this configuration, the example system may be further configured, wherein the security engine comprises a demographic aggregator configured to collect and compile the demographic information, a feedback aggregator configured to collect and compile the feedback and content management configured to control the content displayed on the digital signage. In this configuration, the example system may be further configured, wherein the cloud resources comprise a demographic inference engine configured to process the compiled demographic information, a statistics inference engine configured to process the compiled feedback and a content management engine configured to at least determine the content and the mobile content based on the processed demographic information and the processed feedback.

The above example system may be further configured, wherein the at least one mobile device comprises a plurality of mobile devices, the signage controller being configured to collect the information and the feedback from the plurality of mobile devices via close-proximity or short-range wireless communication and to compile the information and the feedback from the plurality of mobile devices before providing the information and the feedback to the cloud resources.

In another example embodiment there is provided a method. The method may include receiving information from at least one mobile device, receiving feedback from the at least one mobile device, providing the information and feedback to cloud resources; receiving content from the cloud resources, and causing the content to be displayed on digital signage.

The above example method may be further configured, wherein the information includes demographic information for a user of the at least one mobile device. In this configuration, the example method may be further configured, wherein the content and mobile content are determined by the cloud resources based on at least the demographic information and feedback. In this configuration, the example method may be further configured, wherein the content includes at least an advertisement. In this configuration, the example method may be further configured, wherein the feedback is based on acceptance or refusal of an offer pertaining to the advertisement, the offer being displayed based on mobile content received at the at least one mobile device. In this configuration, the example method may further comprise causing statistics to be displayed along with the content, the statistics including at least one of offer acceptance or offer availability statistics for the at least one advertisement based on the feedback.

The above example method may be further configured, wherein the information and feedback are received via at least one of close-proximity wireless communication or short-range wireless communication. In this configuration, the example method may be further configured, wherein the at least one mobile device comprises a plurality of mobile devices and further comprising compiling the information and feedback received from the plurality of mobile devices within at least one of close-proximity or short-range wireless communication range of the digital signage priority to providing the information and feedback to the cloud resources.

In another example embodiment there is provided a system including at least a mobile device, cloud resources and digital signage, the system being arranged to perform any of the above example methods.

In another example embodiment there is provided a chipset arranged to perform any of the above example methods.

In another example embodiment there is provided at least one machine readable medium comprising a plurality of instructions that, in response to be being executed on a computing device, cause the computing device to carry out any of the above example methods.

In another example embodiment there is provided a device comprising at least a signage controller, the device being arranged to perform any of the above example methods.

In another example embodiment there is provided a system comprising at least one machine-readable storage medium having stored thereon individually or in combination, instructions that when executed by one or more processors result in the system carrying out any of the above example methods.

In another example embodiment there is provided a system. The system may include digital signage configured to display content, at least one mobile device configured to receive mobile content related to the content, cloud resources configured to determine the content and the mobile content based on information and feedback, and a signage controller configured to collect the information and the feedback from the at least one mobile device, to provide the information and the feedback to the cloud resources, to receive the content from the cloud resources and to cause the digital signage to display the content.

The above example system may be further configured, wherein the mobile content is configured to cause the at least one mobile device to display acceptance and refusal options for an offer related to at least one advertisement included in the content, to facilitate acceptance or refusal of the offer by a device user, and to provide the feedback to at least the signage controller based on the acceptance or refusal of the offer. In this configuration, the example system may be further configured, wherein the digital signage is further configured to display statistics along with displaying the content, the statistics including at least one of offer acceptance or offer availability statistics for the at least one advertisement based on the feedback.

The above example system may be further configured, wherein the mobile device is further configured to receive the mobile content from at least one of the cloud resources or the signage controller. In this configuration, the example system may be further configured, wherein the information includes at least demographic information corresponding to a user of the at least one mobile device, the demographic information being made available by an application executing on the at least one mobile device. In this configuration, the example system may be further configured, wherein the application is further configured to at least one of filter or store the mobile content received by the at least one mobile device based on a configuration in the application. In this configuration, the example system may be further configured, wherein the signage controller comprises a security engine configured to prevent the signage controller from being compromised through unauthorized access, the security engine comprising a demographic aggregator configured to collect and compile the demographic information, a feedback aggregator configured to collect and compile the feedback and content management configured to control the content displayed on the digital signage. In this configuration, the example system may be further configured, wherein the cloud resources comprise a demographic inference engine configured to process the compiled demographic information, a statistics inference engine configured to process the compiled feedback and a content management engine configured to at least determine the content and the mobile content based on the processed demographic information and the processed feedback.

In another example embodiment there is provided a method. The method may comprise receiving information from at least one mobile device, receiving feedback from the at least one mobile device, providing the information and feedback to cloud resources, receiving content from the cloud resources, and causing the content to be displayed on digital signage.

The above example method may be further configured, wherein the information includes demographic information for a user of the at least one mobile device, the content and mobile content being determined by the cloud resources based on at least the demographic information and feedback.

The above example method may be further configured, wherein the feedback is based on acceptance or refusal of an offer pertaining to an advertisement included in the content, the offer being displayed based on mobile content received at the at least one mobile device. In this configuration, the example method may further comprise causing statistics to be displayed along with the content, the statistics including at least one of offer acceptance or offer availability statistics for the at least one advertisement based on the feedback.

In another example embodiment there is provided a chipset arranged to perform any of the above example methods.

In another example embodiment there is provided at least one machine readable medium comprising a plurality of instructions that, in response to be being executed on a computing device, cause the computing device to carry out any of the above example methods.

In another example embodiment there is provided a device comprising at least one signage controller, the device being arranged to perform any of the above example methods.

In another example embodiment there is provided a system. The system may include digital signage configured to display content, at least one mobile device configured to receive mobile content related to the content, cloud resources configured to determine the content and the mobile content based on information and feedback, and a signage controller configured to collect the information and the feedback from the at least one mobile device, to provide the information and the feedback to the cloud resources, to receive the content from the cloud resources and to cause the digital signage to display the content.

The above example system may be further configured, wherein the content includes at least one advertisement. In this configuration, the example system may be further configured, wherein the mobile content is configured to cause the at least one mobile device to display acceptance and refusal options for an offer related to the at least one advertisement, to facilitate acceptance or refusal of the offer by a device user, and to provide the feedback to at least the signage controller based on the acceptance or refusal of the offer. In this configuration, the example system may be further configured, wherein the digital signage is further configured to display statistics along with displaying the content, the statistics including at least one of offer acceptance or offer availability statistics for the at least one advertisement based on the feedback.

The above example system may be further configured, wherein the mobile device is further configured to receive the mobile content from at least one of the cloud resources or the signage controller. In this configuration, the example system may be further configured, wherein the information includes at least demographic information corresponding to a user of the at least one mobile device, the demographic information being made available by an application executing on the at least one mobile device. In this configuration, the example system may be further configured, wherein the application is a social media application. In this configuration, the example system may be further configured, wherein the application is further configured to at least one of filter or store the mobile content received by the at least one mobile device based on a configuration in the application. In this configuration, the example system may be further configured, wherein the signage controller comprises a security engine configured to prevent the signage controller from being compromised through unauthorized access. In this configuration, the example system may be further configured, wherein the security engine comprises a demographic aggregator configured to collect and compile the demographic information, a feedback aggregator configured to collect and compile the feedback and content management configured to control the content displayed on the digital signage. In this configuration, the example system may be further configured, wherein the cloud resources comprise a demographic inference engine configured to process the compiled demographic information, a statistics inference engine configured to process the compiled feedback and a content management engine configured to at least determine the content and the mobile content based on the processed demographic information and the processed feedback.

The above example system may be further configured, wherein the at least one mobile device comprises a plurality of mobile devices, the signage controller being configured to collect the information and the feedback from the plurality of mobile devices via close-proximity or short-range wireless communication and to compile the information and the feedback from the plurality of mobile devices before providing the information and the feedback to the cloud resources.

In another example embodiment there is provided a method. The method may include receiving information from at least one mobile device, receiving feedback from the at least one mobile device, providing the information and feedback to cloud resources; receiving content from the cloud resources, and causing the content to be displayed on digital signage.

The above example method may be further configured, wherein the information includes demographic information for a user of the at least one mobile device. In this configuration, the example method may be further configured, wherein the content and mobile content are determined by the cloud resources based on at least the demographic information and feedback. In this configuration, the example method may be further configured, wherein the content includes at least an advertisement. In this configuration, the example method may be further configured, wherein the feedback is based on acceptance or refusal of an offer pertaining to the advertisement, the offer being displayed based on mobile content received at the at least one mobile device. In this configuration, the example method may further comprise causing statistics to be displayed along with the content, the statistics including at least one of offer acceptance or offer availability statistics for the at least one advertisement based on the feedback.

The above example method may be further configured, wherein the information and feedback are received via at least one of close-proximity wireless communication or short-range wireless communication. In this configuration, the example method may be further configured, wherein the at least one mobile device comprises a plurality of mobile devices and further comprising compiling the information and feedback received from the plurality of mobile devices within at least one of close-proximity or short-range wireless communication range of the digital signage priority to providing the information and feedback to the cloud resources.

In another example embodiment there is provided a system. The system may include means for receiving information from at least one mobile device, means for receiving feedback from the at least one mobile device, means for providing the information and feedback to cloud resources, means for receiving content from the cloud resources, and means for causing the content to be displayed on digital signage.

The above example system may be further configured, wherein the information includes demographic information for a user of the at least one mobile device. In this configuration, the example system may be further configured, wherein the content and mobile content are determined by the cloud resources based on at least the demographic information and feedback. In this configuration, the example system may be further configured, wherein the content includes at least an advertisement. In this configuration, the example system may be further configured, wherein the feedback is based on acceptance or refusal of an offer pertaining to the advertisement, the offer being displayed based on mobile content received at the at least one mobile device. In this configuration, the example system may further comprise means for causing statistics to be displayed along with the content, the statistics including at least one of offer acceptance or offer availability statistics for the at least one advertisement based on the feedback.

The above example system may be further configured, wherein the information and feedback are received via at least one of close-proximity wireless communication or short-range wireless communication. In this configuration, the example system may be further configured, wherein the at least one mobile device comprises a plurality of mobile devices and further comprising compiling the information and feedback received from the plurality of mobile devices within at least one of close-proximity or short-range wireless communication range of the digital signage priority to providing the information and feedback to the cloud resources.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Accordingly, the claims are intended to cover all such equivalents.

What is claimed:

1. A system, comprising:
digital signage configured to display content;
at least one mobile device configured to receive mobile content related to the content;
cloud resources configured to determine the content and the mobile content based on information and feedback; and
a signage controller configured to collect the information and the feedback from the at least one mobile device, to provide the information and the feedback to the cloud resources, to receive the content from the cloud resources and to cause the digital signage to display the content.

2. The system of claim 1, wherein the content includes at least one advertisement.

3. The system of claim 2, wherein the mobile content is configured to cause the at least one mobile device to display acceptance and refusal options for an offer related to the at least one advertisement, to facilitate acceptance or refusal of the offer by a device user, and to provide the feedback to at least the signage controller based on the acceptance or refusal of the offer.

4. The system of claim 3, wherein the digital signage is further configured to display statistics along with displaying the content, the statistics including at least one of offer acceptance or offer availability statistics for the at least one advertisement based on the feedback.

5. The system of claim 1, wherein the mobile device is further configured to receive the mobile content from at least one of the cloud resources or the signage controller.

6. The system of claim 5, wherein the information includes at least demographic information corresponding to a user of the at least one mobile device, the demographic information being made available by an application executing on the at least one mobile device.

7. The system of claim 6, wherein the application is a social media application.

8. The system of claim 6, wherein the application is further configured to at least one of filter or store the mobile content received by the at least one mobile device based on a configuration in the application.

9. The system of claim 6, wherein the signage controller comprises a security engine configured to prevent the signage controller from being compromised through unauthorized access.

10. The system of claim 9, wherein the security engine comprises a demographic aggregator configured to collect and compile the demographic information, a feedback aggregator configured to collect and compile the feedback and content management configured to control the content displayed on the digital signage.

11. The system of claim 6, wherein the cloud resources comprise a demographic inference engine configured to process the compiled demographic information, a statistics inference engine configured to process the compiled feedback and a content management engine configured to at least determine the content and the mobile content based on the processed demographic information and the processed feedback.

12. The system of claim 1, wherein the at least one mobile device comprises a plurality of mobile devices, the signage controller being configured to collect the information and the feedback from the plurality of mobile devices via close-proximity or short-range wireless communication and to compile the information and the feedback from the plurality of mobile devices before providing the information and the feedback to the cloud resources.

13. A method, comprising:
receiving information from at least one mobile device;
receiving feedback from the at least one mobile device;
providing the information and feedback to cloud resources;
receiving content from the cloud resources; and
causing the content to be displayed on digital signage.

14. The method of claim 13, wherein the information includes demographic information for a user of the at least one mobile device.

15. The method of claim 14, wherein the content and mobile content are determined by the cloud resources based on at least the demographic information and feedback.

16. The method of claim 14, wherein the content includes at least an advertisement.

17. The method of claim 16, wherein the feedback is based on acceptance or refusal of an offer pertaining to the advertisement, the offer being displayed based on mobile content received at the at least one mobile device.

18. The method of claim 17, further comprising causing statistics to be displayed along with the content, the statistics including at least one of offer acceptance or offer availability statistics for the at least one advertisement based on the feedback.

19. The method of claim 13, wherein the information and feedback are received via at least one of close-proximity wireless communication or short-range wireless communication.

20. The method of claim 19, wherein the at least one mobile device comprises a plurality of mobile devices and further comprising compiling the information and feedback received from the plurality of mobile devices within at least one of close-proximity or short-range wireless communication range of the digital signage priority to providing the information and feedback to the cloud resources.

21. A system comprising at least one machine-readable storage medium having stored thereon, individually or in combination, instructions that when executed by one or more processors result in the following operations comprising:
receiving information from at least one mobile device;
receiving feedback from the at least one mobile device;
providing the information and feedback to cloud resources;
receiving content from the cloud resources; and
causing the content to be displayed on digital signage.

22. The system of claim 21, wherein the information includes demographic information for a user of the at least one mobile device.

23. The system of claim 22, wherein the content and mobile content are determined by the cloud resources based on at least the demographic information and feedback.

24. The system of claim 22, wherein the content includes at least an advertisement.

25. The system of claim 25, wherein the feedback is based on acceptance or refusal of an offer pertaining to the advertisement, the offer being displayed based on mobile content received at the at least one mobile device.

26. The system of claim 25, further comprising instructions that when executed by one or more processors result in the following operations comprising:
causing statistics to be displayed along with the content, the statistics including at least one of offer acceptance or offer availability statistics for the at least one advertisement based on the feedback.

27. The system of claim 21, wherein the information and feedback are received via at least one of close-proximity wireless communication or short-range wireless communication.

28. The system of claim 27, wherein the at least one mobile device comprises a plurality of mobile devices and further comprising compiling the information and feedback received from the plurality of mobile devices within at least one of close-proximity or short-range wireless communication range of the digital signage priority to providing the information and feedback to the cloud resources.
